(19) United States
(12) Patent Application Publication
(10) Pub. No.: US 2011/0210122 A1
(43) Pub. Date: Sep. 1, 2011

(54) METHOD FOR FORMING A CLOSURE AND A PRODUCT THEREOF

(75) Inventors: Claude Benoit-Gonin, Odenas (FR); Philippe Bardet, Gleize (FR); Derek John Hindle, Norwich (GB)

(73) Assignee: OBRIST Closures Switzerland GmbH, Reinach (CH)

(21) Appl. No.: 13/045,822

(22) Filed: Mar. 11, 2011

(30) Foreign Application Priority Data
Sep. 11, 2008 (GB) GB 0816643.1
Apr. 17, 2009 (IB) PCT/IB2009/005581
Jan. 12, 2011 (EP) EP 097 859 07.8
Jan. 13, 2011 (GB) GB 110563.4

(51) Int. Cl. B65D 17/42; B26D 3/08

(52) U.S. Cl. 220/277; 83/880

(57) ABSTRACT

A method of forming a tamper-evident closure for a container or a tamper evident fitment is provided. The method comprises the steps of: providing a base; providing a closure with a top plate and a side skirt; applying the closure to the base; and, then after the step of applying, forming a plurality of frangible bridges by slitting the skirt to define a tamper-evident band at the free end of the side skirt. A dispensing fitment for a container is also provided.

### CROSS REFERENCE TO RELATED APPLICATIONS

This application claims priority from UK Patent App. Ser. No. GB 110563.4 filed 13 Jan. 2011, and European Patent App. Ser. No. EP 097 859 07.8 filed 12 Jan. 2011, and International (PCT) Patent App. Ser. No. PCT/IB2009/005581 filed 17 April 2009, which in turn claims priority from UK Patent App. Ser. No. GB 0816643.1 filed 11 Sep. 20089, the entire contents of each of which is herein incorporated fully by reference.

### FIGURE FOR PUBLICATION

FIG. 3.

### BACKGROUND OF THE INVENTION

1. Field of the Invention

The present invention relates generally to a closure and, more particularly, to a tamper-evident closure for a container neck which is itself an integral part of a container.

2. Description of the Related Art

The related art involves collapsable pouches and containers which are used for containing a wide variety of products including food, beverages, personal care and household care, which may be in the form of a liquid, lotion, gel, paste or the like.

Such pouches are typically made from a flexible heat-sealable polymeric sheet or from a flexible, paper boiled or metal foil sheet having a heat-sealable, polymeric lining. The pouch has two opposed flexible sheets which are peripherally sealed to each other so as to define an interior chamber for containing product and to define an opening between the interior and the exterior of the pouch. The opening receives a dispensing fitment with a base defining a dispensing passage and a removable cover for opening or closing the dispensing passage. The base is secured in the opening between the flexible pouch sheets, for example, by heat sealing or adhesion.

Two important considerations in the construction of collapsible pouch dispensing fitments are: ensuring that the fitment is held securely in the opening and between the opposed flexible pouch sheets; and, that the removable cover should be provided with tamper-evident features, but in such a way that it can be easily removed, particularly at the first time of opening.

What is not appreciated by the prior art is that an important consideration in the construction of tamper-evident closures is that the closure should be provided with tamper-evident features in such a way that it can still be easily removed from a container, particularly at the first time of opening.

Accordingly, there is a need for an improved dispensing fitment whereby the fitment is held securely in the opening and between the opposed flexible pouch sheets. And, further, that the removable cover should be provided with tamper-evident features, but in such a way that it can be easily removed, particularly at the first time of opening.

### ASPECTS AND SUMMARY OF THE INVENTION

According to one aspect of the present invention there is provided a dispensing fitment for a collapsible pouch, comprising: a base having a body securable to a pouch and a dispensing passage passing therethrough; and a closure removably attachable to the base to close the dispensing passage, in which the base comprises one or more raised surface formations for assisting with securing the fitment to a pouch.

The surface formations are used to improve the sealing/bonding of the base to the pouch sheets. The surface formations may comprise one or more beads. Beads with a rounded profile are excellent for sealing against laminar sheets. Other types of surface formations such as ribs, bosses, protrusions, splines, and the like, are possible.

The raised surface formations may extend generally perpendicular to the main axis of the base. Alternatively, for example, axially or randomly extending and distributed formations may be provided. The raised surface formations may extend around the outer periphery of the base. In this way, bead hoops could be provided.

The base may comprise one or more fins. Two fins may be provided, one at each side of the base. The surface formations may extend at least partly over the fins to aid engagement.

Many industries require a tamper-evident system for their products. To satisfy that requirement, the lid may comprise a tamper-evident band. The band may be joined to the free end of the side skirt by a plurality of frangible bridges. The bridges are then adapted to break on first opening so that the band separates from the remainder of the lid. The bridges may be formed by slitting the side skirt. The band may be adapted to be retained on the base following a first opening.

The slitting operation may be performed after the lid is applied to the base. In this way the lid can be applied to the base and then extremely thin bridges can be formed after capping because there is no risk of breakage during capping. Thin bridges can then be used to reduce the required opening torque.

According to another aspect of the present invention, there is provided a method of forming a tamper-evident closure for a container, comprising the steps of: providing a closure with a top plate and a side skirt; applying the closure to a container neck; and, forming a plurality of frangible bridges by slitting the side skirt after the closure is applied to the neck to define a tamper-evident band at the free end of the skirt.

According to a further aspect of the present invention, there is provided a collapsible pouch having a dispensing fitment as defined herein.

According to a further aspect of the present invention there is provided a method of forming a tamper-evident fitment for a collapsible pouch; the method comprises a number of steps that begin with providing a base, then a lid with a top plate and a side wall. The lid is applied to the base; and, a plurality of frangible bridges are formed in the sidewall to define a tamper evident band at the free end of the sidewall.

According to a further aspect of the present invention there is provided a closure for a container, comprising a top plate and a side skirt, the side skirt comprises a plurality of frangible bridges defining a tamper evident band at its free end, in which the bridges are formed by slitting the skirt after the closure has been applied to a container. The closure may have a disc-shape top plate and a cylindrical skirt.

The band is joined to the free end of the side skirt by a plurality of frangible bridges that are adapted to break on first opening so that the band separates from the remainder of the closure. The band may be adapted to be retained on the base following first opening.

The bridges are formed by slitting the side skirt. The slitting operation is performed after the closure is applied to the container. In this way, the closure can be applied to a container neck and then extremely thin bridges can be formed after capping because there is no risk of breakage during capping. Thinner bridges can be used to reduce the required opening torque.

By forming the bridges only after capping, for example by slitting, the extent of the bridges can be reduced so that, in turn, the opening torque can be reduced. In some embodiments, the ratio of slit length to bridge length is in the range 10:1 to 50:1; and, in one embodiment is approximately 20:1.

According to one aspect of the present invention there is provided a closure which goes directly onto a container neck (which itself is an integral part of a container.

According to another aspect of the present invention there is provided complementary structure on a closure and/or container neck which allows a tamper evident band to be formed according to the teachings herein and retained following a use.

According to another aspect of the present invention there is provided a method of forming a tamper-evident closure for a container, comprising the steps of: a) providing a container neck, b) providing a closure with a top plate and a side skirt, c) applying the closure to the container neck, d) after step (c) performing a step of slitting a plurality of frangible bridges at the free end of the skirt to form a tamper evident band.

According to another aspect of the present invention there is provided a closure for a container neck, comprising a top plate and a side skirt, the side skirt comprises a plurality of frangible bridges defining a tamper evident band at its free end, in which the bridges are formed by slitting the skirt only after the closure has been applied to a container.

The above, and other aspects, features and advantages of the present invention will become apparent from the following description read in conjunction with the accompanying drawings, in which like reference numerals designate the same elements.

### BRIEF DESCRIPTION OF THE DRAWINGS

FIG. 1 is a side view of a collapsible pouch having a fitment formed in accordance with the present invention.

FIG. 2 is a front elevation of the pouch of FIG. 1.

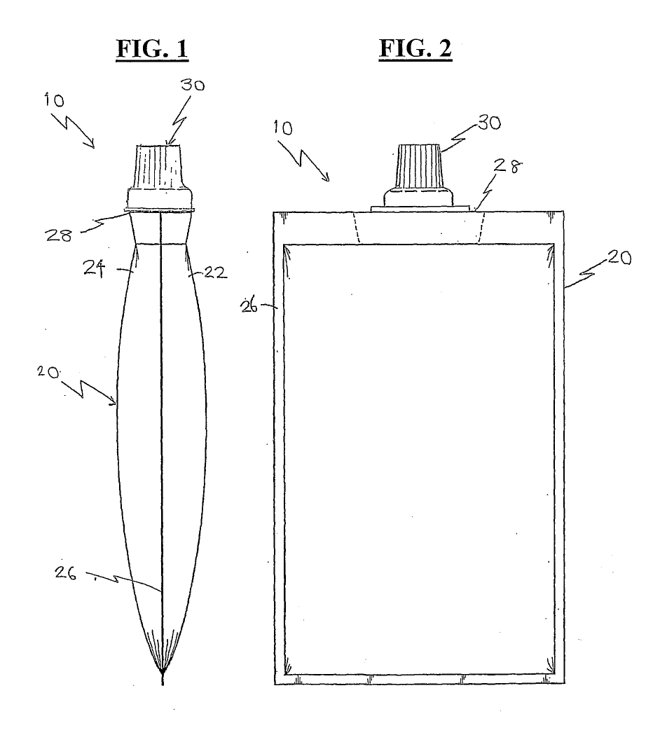

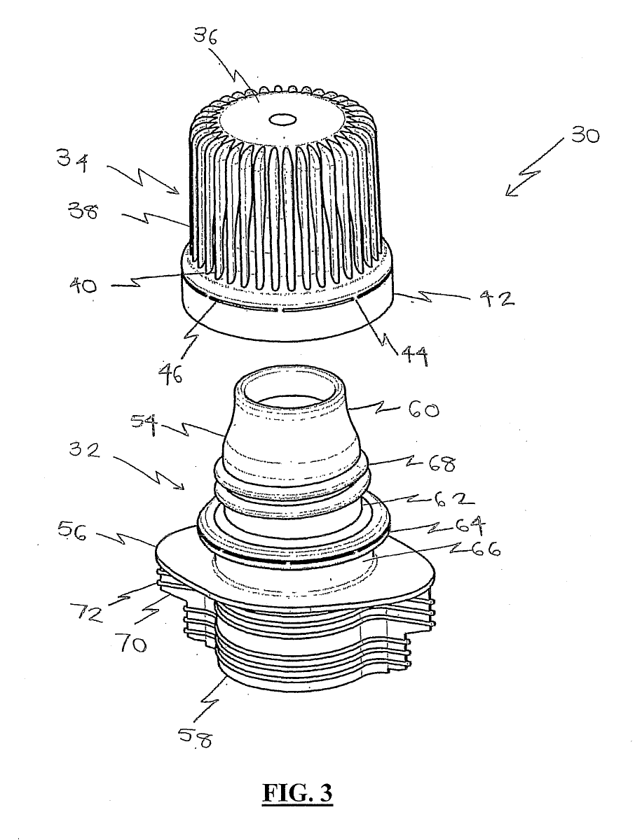

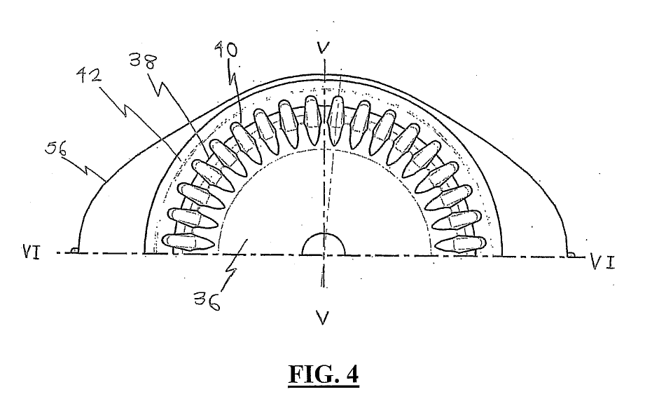

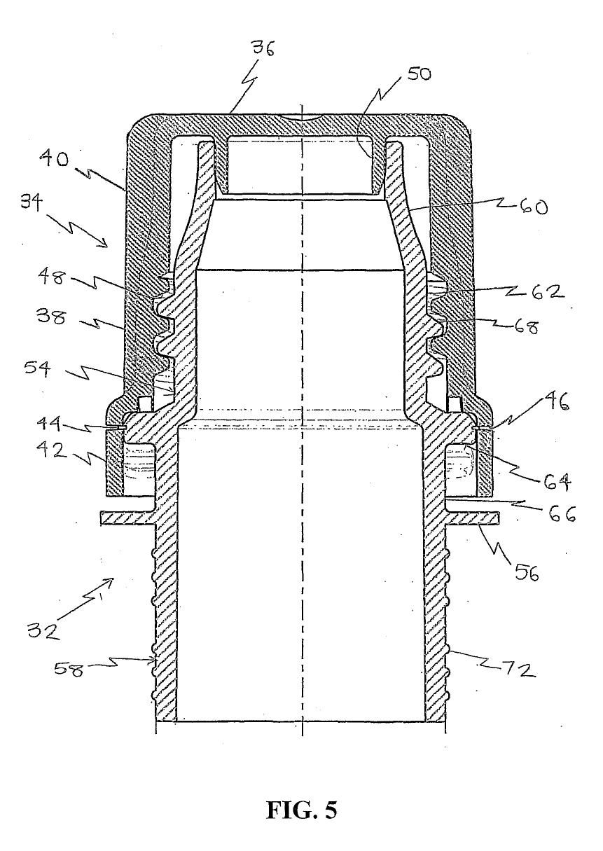

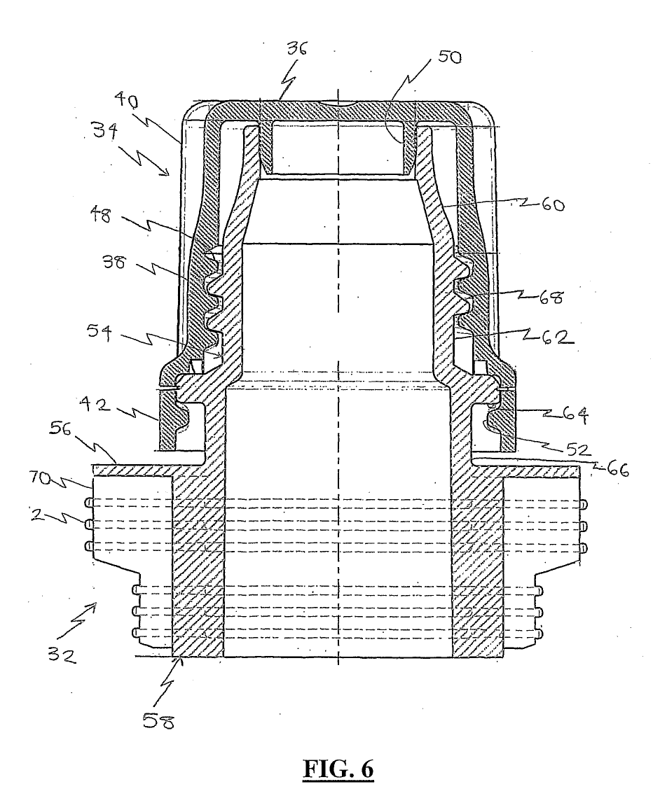

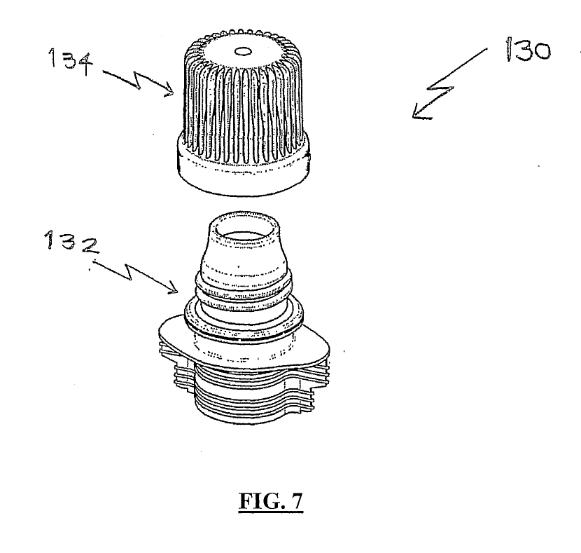

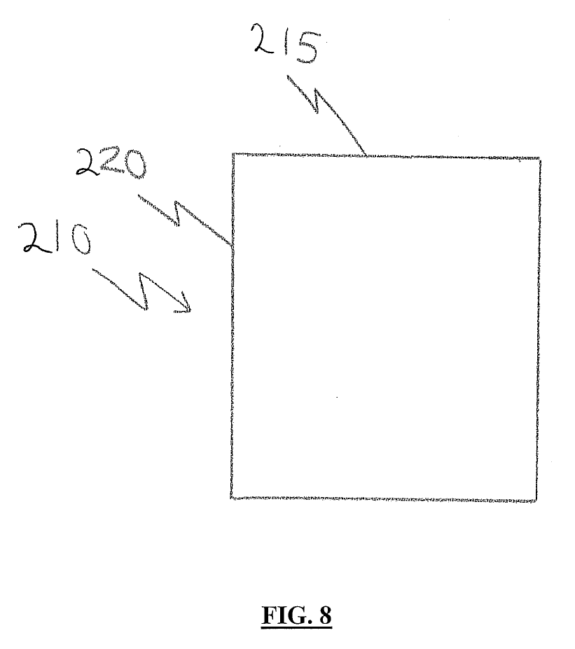

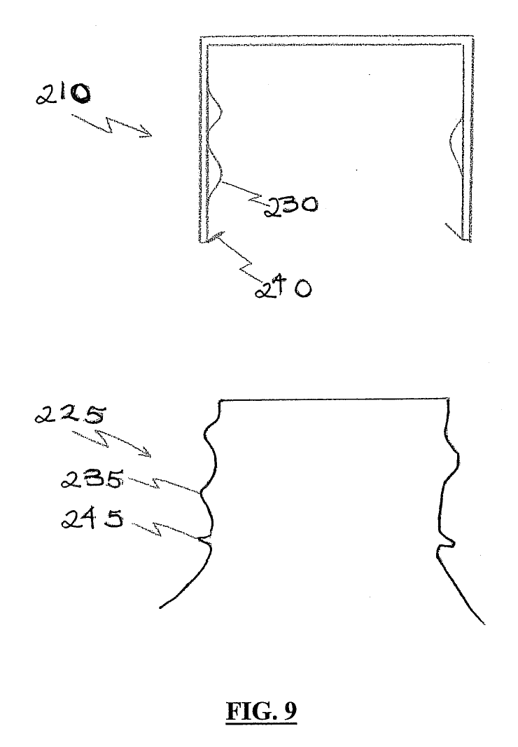

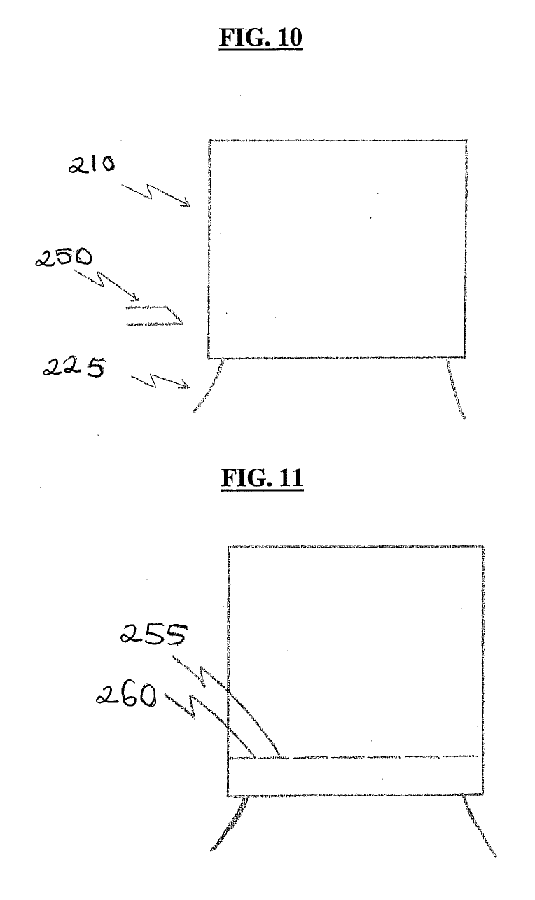

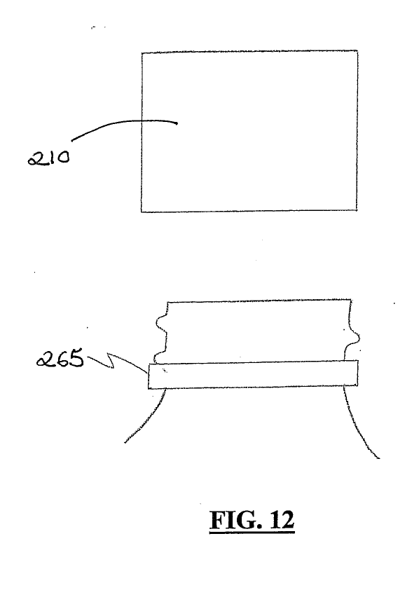

FIG. 3 is an exploded perspective view of the fitment of FIGS. 1 and 2.

FIG. 4 is a plan view of the fitment of FIG. 3.

FIG. 5 is a section of the closure of FIG. 4 shown along line v-v.

FIG. 6 is a section of the closure of FIG. 4 shown along line vi-vi.

FIG. 7 is an exploded perspective view of a fitment formed in accordance with a method of the present invention.

FIG. 8 is a side elevation of a closure formed according to the present invention.

FIG. 9 is a section of the closure shown presented to a container neck prior to capping.

FIG. 10 is a side elevation of the closure shown attached to the container neck.

FIG. 11 is a side elevation of the closure/container of FIG. 3 following a slitting step.

FIG. 12 is a side elevation of the closure/container of FIG. 4 following removal of the closure.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

Referring first to FIGS. 1 and 2 there is shown a container 10 comprising a collapsible pouch 20 and a dispensing fitment 30.

The pouch 20 comprises a generally rectangular bag-like structure formed from a front sheet 22 and a rear sheet 24 which are made from metal foil sheets having heat-sealable polymeric linings. The sheets 22, 24 are heat-sealed together at their peripheries to form a seam 26. The seam 26 extends around the periphery of the sheets except for along the top edge where an opening 28 is formed.

The opening 28 receives the fitment 30, which in this embodiment is also heat sealed to the two sheets either side of the opening 28.

Referring now to FIGS. 3 thru 6, the fitment 30 is shown in more detail.

The fitment 30 comprises a base 32 and a removable closure or lid 34. The lid 34 comprises a circular top plate 36 with a sidewall 38 depending from the periphery thereof The base 32 comprises a spout region 54, a deck 56, and a sealing part 58.

The sidewall 38 has a plurality of axial splines 40 for improving grip. At the open end of the sidewall 38, a tamper-evident band 42 is formed by a plurality of frangible bridges 44 which are defined between arcuate slits 46. The interior of the sidewall 38 is provided with screw threads 48 and the interior of the top plate 36 is provided with an annular sealing ring 50. The interior of the tamper-evident band 42 is provided with an annular locking bead 52.

The spout region 54 comprises a generally frustoconical mouth region 60, a central chimney section 62, a locking ring 64 and a terminal portion 66. The mouth portion 60 receives the sealing ring 50 on the lid 34 so as to seal the spout. The central section 62 is provided with external screw threads 68 for cooperating with the screw threads 48 on the lid 34. The locking ring 64 is positioned so that the locking bead 52 on the tamper-evident band 42 fits beneath it and prevents axially upward movement of the band with the remainder of the lid 34, so that in use when the lid 34 is unscrewed the band 42 remains beneath the ring 64 and the remainder of the lid 34 can be unscrewed and removed. The terminal portion 66 adjoins the locking ring 64 to the deck 56 and accommodates the tamper-evident band 42.

The deck 56 is a generally ellipsoidal plate, or flange, from which the sealing section 58 depends effectively as a continuation of the terminal portion 66.

The sealing section 58 is generally cylindrical and is provided with two diametrically opposed sealing fins 70. The exterior of the sealing section 58 is provided with a series (in this embodiment six) of sealing beads 72 which extend around the central body and the fins. The beads 72 improve the sealing of the sealing section to the pouch sheets. Other types of surface formations, such as bosses, ribs, splines and the like are of course possible.

In use, the sealing section 58 is fitted into the opening 28 between the sheets 22, 24. This may be before, or after, filling of the pouch. The sealing section 58 is sealed into the opening 28 between the sheets 22, 24 so that the deck 56 rests on top of the opening 28 (as shown best in FIGS. 1 and 2).

When the contents of the container 10 are required, the closure 34 is unscrewed so that the frangible bridges 44 break and the tamper-evident band 42 drops so as to rest on top of the deck 56; the remainder of the closure is removed and can be replaced to seal any remaining contents of the pouch if required. In this embodiment, the frangible bridges 44 are formed in the closure sidewall 38 before it is applied to the base 32.

Referring now to FIG. 7, there is shown a fitment 130 formed according to an alternative aspect of the present invention.

The fitment is very similar to the fitment 30 shown in FIG. 3. However, in this embodiment the closure 134 does not have frangible bridges prior to application to the base. Instead, the closure 134 is first applied and then frangible bridges (not shown) are formed by slitting.

Referring then to FIG. 8, there is shown a closure generally indicated 210. The closure 210 comprises a generally cup-like body with a disc-shape top plate 215 and a generally cylindrical side skirt 220 depending from the periphery thereof In this embodiment, the closure is thermoformed from a plastics material (such as polypropylene or polyethylene) by an injection molding process.

As is best shown in FIG. 9, the closure 210 is intended to be used in conjunction with a container i.e. it is to be directly applied (“capped”) onto a container neck 225 as shown in FIG. 9. In this embodiment, the closure 210 and neck 225 are provided with co-operating screw thread formations 230, 235 to facilitate connection. Other connection means (such as snap engagement) are possible.

The free end of the skirt 220 is provided with an upturned flap 240 which is adapted to engage under a transfer bead 245 on the neck 225.

The closure 210 can be applied to the neck 225 by any conventional means so that the flap 240 engages under the bead as is shown in FIG. 10.

Only after capping, a slitting tool 250 is used to form a plurality of slits 255 that define a plurality of frangible bridges 260 as is shown in FIG. 11. Because the bridges 260 are formed after capping, the risk of breakage during capping is removed. Accordingly, using the post-capping slitting method, the bridges can be made much thinner than with a pre-capping slitting method.

When the closure is first removed in use, the engagement of the flap 240 under the bead 245 prevents axial movement of the portion of the skirt 220 below the break line defined by the slits 255. Accordingly, the skirt 220 breaks along the line to leave a tamper-evident band 265 which is retained on the neck 225 while the remainder of the closure 210 is removed as is shown in FIG. 12.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A method of forming a tamper-evident closure for a container, comprising the steps of:
(a) providing a container neck
(b) providing a closure with a top plate and a side skirt;
(c) applying the closure to the container neck; and
(d) after said step of applying, performing a step of slitting a plurality of frangible bridges at the free end of the skirt to form a tamper evident band.

2. The method according to claim 1, wherein the container neck is comprised within a dispensing fitment which further comprises: a base which comprises at least one raised surface formations for operable for assisting with securing the container neck to a pouch.

3. The method according to claim 2, wherein the dispensing fitment comprise a dispensing passage passing therethrough.

4. The method according to claim 3, wherein the or each surface formations comprise one or more beads; and each said formation extending generally perpendicular to the main axis of the base.

5. A closure for a container neck, comprising: a top plate and a side skirt, the side skirt comprises a plurality of frangible bridges defining a tamper evident band at its free end, in which the bridges are formed by slitting the skirt after the closure has been applied to a container.

6. A method of forming a tamper-evident fitment, said method comprising the steps of:
(a) providing a base;
(b) providing a closure with a top plate and a side skirt;
(c) applying said closure to said base; and
(d) slitting, after said applying step, said side skirt to form one or more slits to define a tamper evident-band at the free end of said side skirt and forming a plurality of frangible bridges thereby.

7. The method of claim 6, comprising the further step of adapting said tamper-evident band to be retained on said base following a first opening of said closure.

8. The method of claim 6, wherein the ratio of the length of said one or more slits to the length of said plurality of frangible bridges is in the range 10:1 to 50:1.

9. The method of claim 8, wherein said ratio is approximately 20:1.

10. The method of claim 6, further comprising the step of providing said base with one or more raised surface formations for assisting with securing said fitment to said pouch by forming a seal with an opposing wall.

11. The method of claim 10, wherein said one or more raised surface formations comprises at least one of:
one or more beads;
an extension extending generally perpendicular to the main axis of said base;
an extension generally perpendicular to the main axis of said base; and
an extension around the outer periphery of said base.

12. A dispensing fitment, said dispensing fitment comprising:
(a) a base having a body securable to a pouch and a dispensing passage passing therethrough; and
(b) a closure having a top plate and a side skirt, which closure is removably attachable to said base to close said dispensing passage, and in which said closure further comprises:
(i) a tamper-evident band joined to the free end of said side skirt by a plurality of frangible bridges; and, wherein said plurality of frangible bridges are formed by slitting said side skirt to form one or more slits.

13. A dispensing fitment as claimed in claim 12, in which said base comprises one or more raised surface formations for assisting with securing said fitment to said pouch.

14. A dispensing fitment as claimed in claim 12, in which said base comprises one or more fins.

15. A dispensing fitment as claimed in claim 14, in which said one or more raised surface formations extend at least partly over said one or more fins.

16. A dispensing fitment as claimed in claim 12, in which the ratio of the length of said one or more slits to the length of said plurality of bridges is in the range 10:1 to 50:1.

17. A dispensing fitment as claimed in claim 16, wherein said ratio is approximately 20:1.

18. A dispensing fitment as claimed in claim 12, in which said tamper-evident band is adapted to be retained on said base following a first opening.

19. A dispensing fitment as claimed in claim 13, in which said one or more raised surface formations comprise one or more beads.

20. A dispensing fitment as claimed in claim 14, wherein said one or more raised surface formations comprise at least one of the following characteristics:
(a) extend generally perpendicular to the main axis of said base;
(b) extend around the outer periphery of said base; and
(c) extend at least partly over said one or more fins.

21. A method of forming a tamper-evident fitment, said method comprising the steps of:
(a) providing a base, said base further comprising one or more fins;
(b) providing a closure with a top plate and a side skirt;
(c) applying said closure to said base; and
(d) slitting, after application of said closure to said base, said side skirt to form one or more slits to define a tamper evident-band at the free end of said side skirt and forming a plurality of frangible bridges thereby.

22. The method of claim 21, said method further comprising the step of maintaining a ratio of the length of said one or more slits to the length of said plurality of bridges in the range 10:1 to 50:1.

23. The method of claim 21, said method further comprising the step of adapting said band to be retained on said base following a first opening.

24. The method of claim 21, said method further comprising the step of utilizing one or more raised formations on said base for assisting with securing said fitment to said pouch.

25. The method of claim 24, said method further comprising the step of constructing said one or more raised surface formations so as to comprise one or more beads.

26. The method of claim 24, said method further comprising the step of adapting said one or more raised surface formations so as to extend generally perpendicular to the main axis of said base.

27. The method of claim 24, said method further comprising the step of adapting said one or more raised surface formations so as to extend around the outer periphery of said base.

28. The method of claim 24, said method further comprising the step of adapting said one or more raised surface formations so as to extend at least partly over said one or more fins.

29. A dispensing fitment, said dispensing fitment comprising:
(a) a base, said base further comprising:
(i) a body securable to a pouch and a dispensing passage passing therethrough;
(ii) a set of one or more raised surface formations for assisting with securing said fitment to said pouch; and
(iii) a set of one or more fins;
(b) a closure having a top plate and a side skirt, and wherein said closure is directly connected to a container neck to close said dispensing passage, and wherein said closure further comprises:
(i) a tamper-evident band joined to the free end of said side skirt by a plurality of frangible bridges; and, wherein said plurality of frangible bridges are formed by slitting said side skirt to form one or more slits.

30. The dispensing fitment of claim 29 wherein said one or more raised surface formations comprise at least one of the following characteristics: extend generally perpendicular to the main axis of said base;
(b) extend around the outer periphery of said base; and extend at least partly over said one or more fins.
